(19) United States
(12) Patent Application Publication
(10) Pub. No.: US 2008/0282054 A1
(43) Pub. Date: Nov. 13, 2008

(54) SEMICONDUCTOR DEVICE HAVING MEMORY ACCESS MECHANISM WITH ADDRESS-TRANSLATING FUNCTION

(76) Inventor: Takanori Isono, Kyoto (JP)

Correspondence Address: MCDERMOTT WILL & EMERY LLP, 600 13TH STREET, NW, WASHINGTON, DC, 20005-3096, US

(21) Appl. No.: 12/048,973

(22) Filed: Mar. 14, 2008

(30) Foreign Application Priority Data
May 8, 2007 (JP) 2007-123007

(51) Int. Cl. G06F 12/10

(52) U.S. Cl. 711/206; 711/E12.058

(57) ABSTRACT

A pseudo-physical address is used for accessing a memory from a CPU (Central Processing Unit). One of function blocks that is needed for the current application program is selected based on the pseudo-physical address, and the pseudo-physical address is translated to a real physical address by the selected function block. There are provided parallel lines of memory access functions extending from the CPU, whereby it is possible to perform an optimal memory access transaction for each application program, and it is possible to improve the memory access performance without lowering the operation frequency and without increasing the number of cycles required for a memory access.

### BACKGROUND OF THE INVENTION

The present invention relates to a system having a CPU (Central Processing Unit) and a memory, and more particularly to a technique for transferring data to the memory.

With conventional systems having a CPU and a memory, the increase in the memory access speed has not been able to keep up with the increase in the CPU speed. Typically, cache memories are employed for improving the memory access performance. In recent years, such a system employs not only a level 1 cache but also a level 2 cache, and may further employ a level 3 cache.

FIG. 1 is a block diagram showing a conventional memory access technique. The system of FIG. 1 includes first and second semiconductor devices 100 and 200. The first semiconductor device 100 includes a CPU 10, a level 2 cache 20, and a real memory 30. The level 2 cache 20 includes a cache memory 21 and a control circuit 22. The second semiconductor device 200 includes a real memory 40. The CPU 10 is connected to both of the real memories 30 and 40 via the level 2 cache 20.

Another technique called “virtual memory” has also been employed, whereby a memory space other than the real physical memory space is available to an application program. There is provided a function of translating a virtual address specified by the application program to a real physical address inside the CPU. With this function, the real physical memory can be accessed. The capacity of a real physical memory space is normally limited, and the virtual memory technique is very useful because the memory space that can be accessed by the application program is made to appear larger to the application program. Since the capacity of a real physical memory is limited as described above, data or application programs that should be placed on the real physical memory are dynamically assigned, as demanded an application program, thus efficiently using the limited real physical memory.

With a cache memory as described above, memory data that is once accessed is taken into the cache so that when an access is next made to the same address, the cache, instead of the memory, is accessed, thus improving the memory performance.

With any system using a CPU, the memory access performance is likely to be the bottleneck, and improving the memory access performance has become very important.

With write accesses to a cache memory or a memory, the data overwrite function is provided, thereby increasing the write access speed. Write data is first taken into a write buffer inside the level 2 cache control circuit. With a write buffer having the data overwrite function, when there occurs a write access to an address of the same address group (e.g., the same cache line) as that of write data remaining in the write buffer, the write access is overwritten within the write buffer. A write buffer with no data overwrite function produces a write access to a cache memory or a memory each time there is a write access, without being able to overwrite write accesses, whereas a write buffer with a data overwrite function can reduce the total number of write accesses to occur and processing write accesses of the same cache line as a single transaction, thus enabling faster write accesses (see L220 Cache Controller Revision r1p4 Technical Reference Manual, ARM Limited).

With a semiconductor device employing a cache memory as described above, the number of accesses to a memory can be reduced, thus enabling a faster operation. However, when image data, or the like, is output to an external display device such as a liquid crystal display device, such data need to be stored in a frame buffer such as a memory, instead of in a cache. Then, with a semiconductor device having a level 2 cache, it is necessary to transfer data to the memory without using the level 2 cache.

There are cases where data on a memory is shared between the CPU and a non-CPU master block that uses a memory. In such a case, any write data from the CPU is typically written directly to the memory without using the cache function, thereby maintaining the data coherency with the master block.

However, even when the level 2 cache is not used, the write data needs to pass through the level 2 cache control circuit, accordingly requiring excessive clock cycles for the memory access.

Moreover, the addition of a data overwrite function as described above to the level 2 cache control circuit complicates the logic of the level 2 cache control circuit, and makes it difficult to increase the clock speed of the level 2 cache. Inserting flip flops in order to increase the operation frequency of the level 2 cache control circuit will increase the memory access latency. In either case, the memory access performance is lowered.

As described above, adding various memory access functions according to the types of data processing to be done by application programs will complicate the control logic and thereby preventing the memory access performance from being improved.

### SUMMARY OF THE INVENTION

The present invention solves problems as set forth above.

The essence of the present invention lies in that various functions between the CPU and the memory, such as the level 2 cache, the data overwrite function and the data bypass function, are provided in the form of function blocks, which are selected based on pseudo-physical addresses.

For example, referring to FIG. 2, a memory access from the CPU 10 selects a first function block 51 based on the pseudo-physical address “A”. As the memory access is processed through the first function block 51, the pseudo-physical address “A” is translated to the real physical address “C”, and then the memory 40 is accessed. When there is a memory access from the CPU 10 specifying the pseudo-physical address “B”, the memory access is processed through a second function block 52, and the address is translated to the real physical address “C”, based on which the memory is accessed. The real physical address “C”, as translated through the first and second function blocks 51 and 52, does not need to indicate the real physical address area “C” for both function blocks, but the function blocks may translate the addresses to different address areas. The same effect is obtained also when the real physical space is on the same semiconductor device 100.

Similar effects are obtained also when the address is not translated through a second function block 62, whereby the pseudo-physical address is equal to the real physical address, as shown in FIG. 3. This is advantageous in cases where most of the processes are performed by the second function block 62 with a first function block 61 being used only in special and rare cases, wherein the system can be realized with no one except for some software engineers being aware of the pseudo-physical address.

While functions such as the cache memory for increasing the data reading speed and the data overwrite function for increasing the data writing speed are needed between the CPU 10 and the memories 30 and 40 in cases as shown in FIGS. 2 and 3, the particular function needed varies for each application program. For example, when accessing a shared memory or when displaying an image on an external display device, as described above, the cache memory is not needed, but the data overwrite function is required for displaying the image with a high speed. Moreover, the size of the real physical memory space is limited, and data or an application program to be placed at the same real physical address is changed dynamically.

This means that the application program to be placed at the same real physical address changes over time, thus needing a different memory transfer function each time such a change occurs.

In view of this, a pseudo-physical address is first output from the CPU 10 to select one of the function blocks 51, 52, . . . (or 61, 62, . . . ) that is most suitable to and needed by the current application program. As each of the function blocks 51, 52, 61, and 62 is capable of translating a pseudo-physical address to a real physical address, the real memory 30 or 40 can be accessed properly. A virtual address, used for realizing a virtual memory, may be translated to a pseudo-physical address inside the CPU 10.

As described above, since the same real physical address may carry different data or different instruction codes over time, the function blocks 51, 52, 61, and 62 are provided with the function of producing the same real physical address from different pseudo-physical addresses. Therefore, only by changing the pseudo-physical address, it is possible to change the function block through which a transaction passes, yet accessing the same real physical address.

With the use of the pseudo-physical address, the inside of each function block can be dedicated to a single function process. Thus, each of the function blocks 51, 52, 61, and 62 can be simplified, and it is possible to increase the operation frequency thereof or to realize a fast operation without inserting additional registers.

As described above, the present invention improves memory accesses from the CPU while optimizing them to each application program.

The method of each function block for translating a pseudo-physical address to a real physical address may be fixed or dynamically changed. When data at the same real physical address is changed by transactions passing through different function blocks, the function blocks can communicate with each other to ensure the data coherency.

### BRIEF DESCRIPTION OF THE DRAWINGS

FIG. 1 is a block diagram showing a conventional memory access technique.

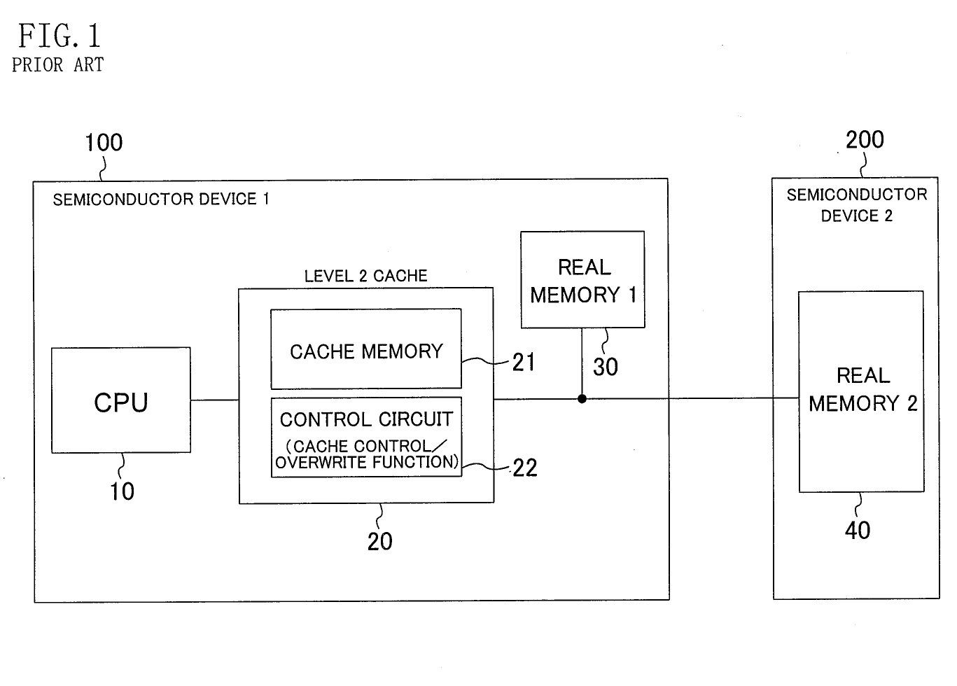

FIG. 2 is a block diagram showing a memory access technique of the present invention.

FIG. 3 is a block diagram showing another memory access technique of the present invention.

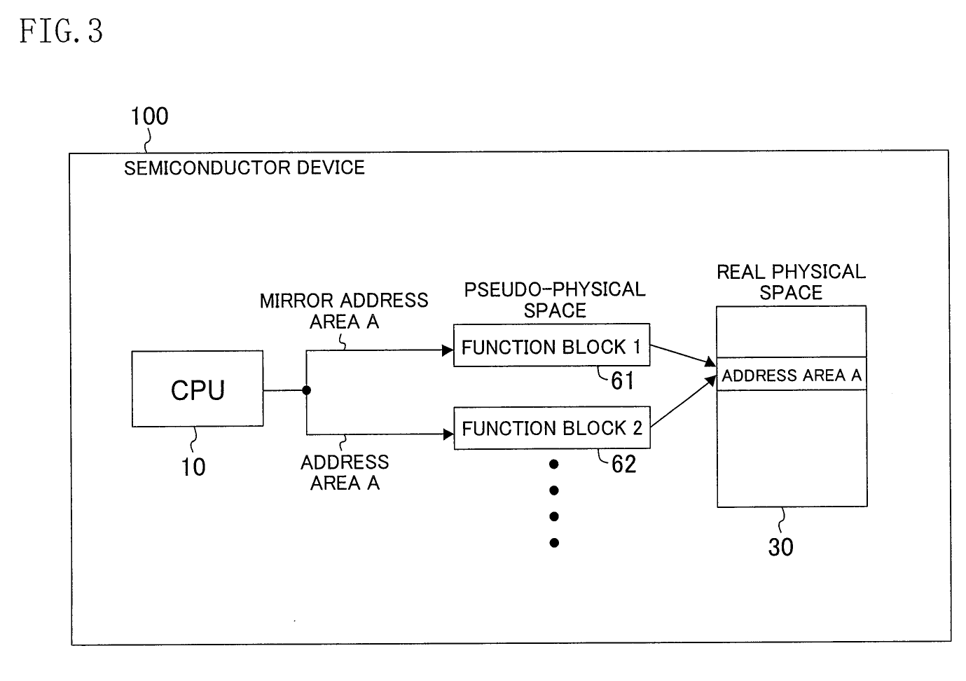

FIG. 4 is a block diagram showing a memory access technique in one embodiment of the present invention.

FIG. 5 shows an address map in one embodiment of the present invention.

### DETAILED DESCRIPTION OF THE INVENTION

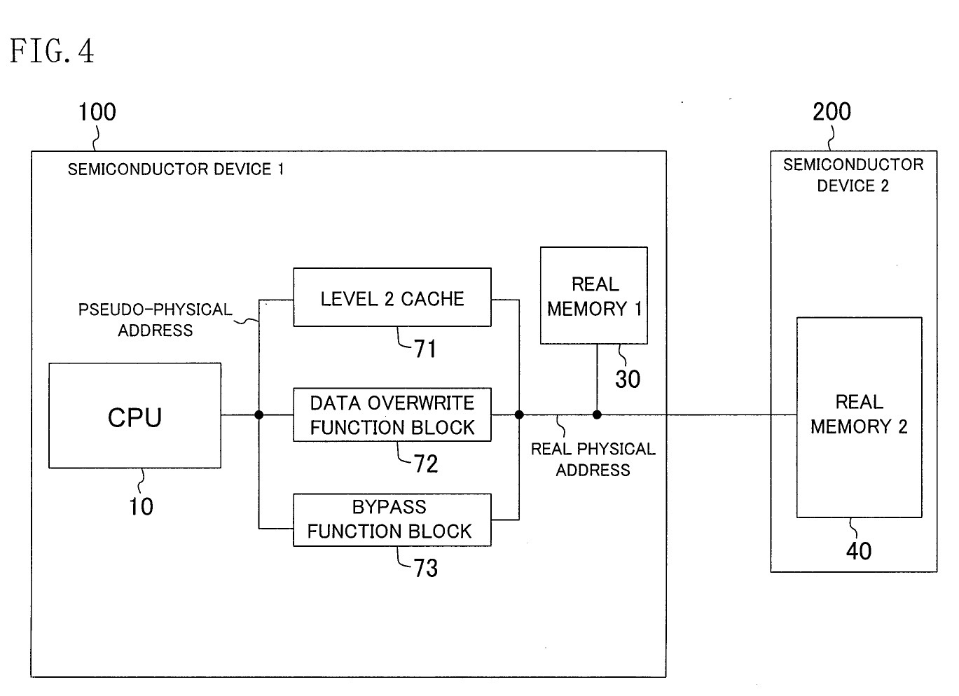

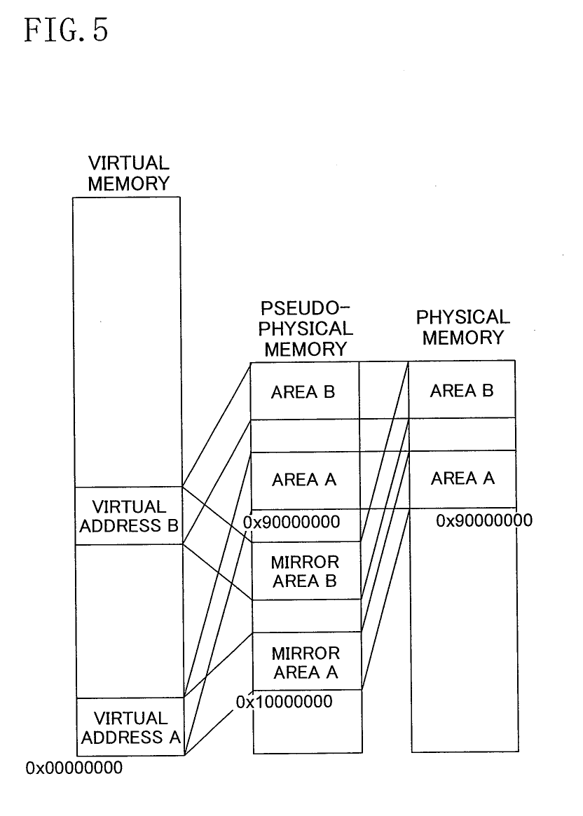

Referring now to FIGS. 4 and 5, a semiconductor device of the present invention will be described.

FIG. 4 is a block diagram showing a memory access technique in one embodiment of the present invention. FIG. 4 shows, as function blocks, a level 2 cache 71, a data overwrite function block 72, and a bypass function block 73.

The data overwrite function block 72 is capable of merging write accesses to the same address space into a single memory transfer. When more than one data are written to the same address, the most recently written piece of data is output. In other words, the block is capable of overwriting data.

The bypass function block 73 represents a block that only translates memory access addresses, and does not have the cache function or the data overwrite function. As described above, the real physical space may be provided on the same semiconductor device 100 with the CPU 10, as is the real memory 30, or may be provided on a different semiconductor device 200 from the semiconductor device 100 carrying the CPU 10, as is the real memory 40.

FIG. 5 shows an address map in one embodiment of the present invention, showing how virtual addresses, pseudo-physical addresses and physical addresses are associated with one another.

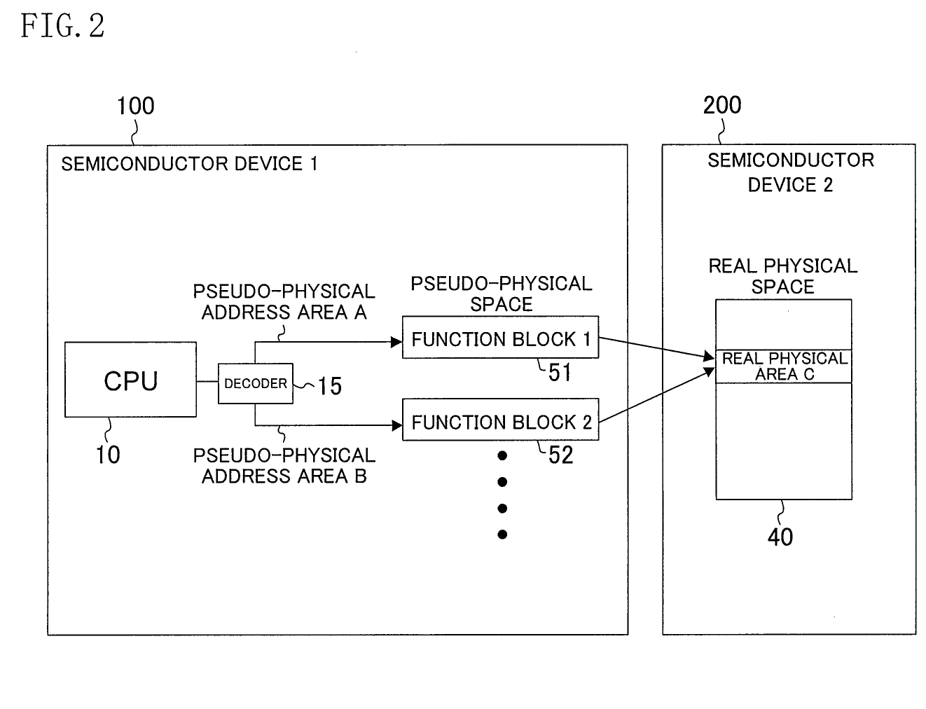

Referring to FIG. 5, where “0x” denotes hexadecimal, the virtual address 0x00000000 based on the virtual memory mechanism of the CPU 10 is translated to the pseudo-virtual address 0x10000000. The CPU 10 outputs the pseudo-virtual address 0x10000000, and the address decoder (see 15 in FIG. 2) provided between the CPU 10 and the level 2 cache 71 and the data overwrite function block 72 outputs data to the data overwrite function block 72. Thus, the pseudo-physical memory mirror area “A” in FIG. 5 is an address space of the data overwrite function block 72.

When the virtual address 0x00000000 is translated to the pseudo-virtual address 0x90000000 by the virtual memory mechanism, data is sent to the level 2 cache 71, but not to the data overwrite function block 72. The pseudo-physical memory area “A” in FIG. 5 means that the transaction passes through the level 2 cache 71.

Where data is sent to the data overwrite function block 72, if there exists data in the write buffer that is in the same address group in the block 72, the existing data is overwritten inside the write buffer by the recently-written data. Then, when data are drained from the write buffer, the recently-written data is written, together with the existing data in the write buffer, to the memories 30 and 40. The data are written to the memories 30 and 40 after the address is translated to the physical address 0x90000000. Specifically, data are written to the memories 30 and 40 while the virtual address 0x00000000 is translated to the pseudo-physical address 0x10000000 and then to the physical address 0x90000000.

The level 2 cache 71 and the data overwrite function block 72 each have a cache memory and a write buffer, and include a register that can be accessed from an application program so as to explicitly send out data from these data holding mechanisms to the memories 30 and 40. By accessing the register, data remaining in the level 2 cache 71 or in the data overwrite function block 72 can reliably be transferred to the memories 30 and 40. Even without the register, the same effects can be realized as long as data can be explicitly drained by an application program.

Referring to FIG. 5, the virtual address 0x00000000 of the virtual memory can be translated to the pseudo-physical address 0x90000000 to access the level 2 cache 71 to eventually access the physical address 0x90000000, as does the data overwrite function block 72.

Thus, where a plurality of application programs share the physical memory at the same address, the level 2 cache 71 or the data overwrite function block 72 can be selectively used according to the characteristic of each application program, thus making maximum use of the memory performance. This is so in view of the fact that some application programs run better with the cache function while others may run better with the data overwrite function.

The method of translating a pseudo-physical address to a physical address may be changeable by the application program, thus realizing a flexible address translation. For example, if the application program is allowed to choose whether the pseudo-physical address 0x10000000 is translated to the physical address 0x90000000 or to the physical address 0xA0000000, an effective address translation is realized even when the physical memories 30 and 40 are even more limited in capacity.

Conversely, it may be more advantageous in some cases if the address translation is uniquely dictated by means of hardware, in which case the memory access performance can be improved with small hardware and without having to insert excessive flip flops.

It is understood that specific address values used in the description above are merely illustrative, and similar effects can be provided also with other address values.

The circuit technique of the present invention can improve the memory access performance, and is useful as a high-speed data processing device, or the like.

What is claimed is:

1. A semiconductor device having a CPU (Central Processing Unit) accessing a memory, the semiconductor device comprising two or more blocks for translating a pseudo-physical address from the CPU to a real physical address, wherein an access from the CPU to the memory passes through at least one of the blocks, with the at least one block being selected based on the pseudo-physical address, and a location of the memory to be accessed being selected based on the real physical address.

2. The semiconductor device of claim 1, wherein the memory is internal or external to the semiconductor device.

3. The semiconductor device of claim 1, wherein there is provided a mechanism for translating a virtual address to the pseudo-physical address within the CPU.

4. The semiconductor device of claim 1, wherein different pseudo-physical addresses can be translated by different blocks to the same physical address.

5. The semiconductor device of claim 1, wherein a method of each block for translating the pseudo-physical address to the real physical address can be changed dynamically.

6. The semiconductor device of claim 1, wherein a method of each block for translating the pseudo-physical address to the real physical address cannot be changed.

7. The semiconductor device of claim 1, wherein when data at the same real physical address is changed by transactions passing through different blocks, the blocks communicate with each other to ensure data coherency.

8. The semiconductor device of claim 1, wherein at least one of the blocks has a cache memory function.

9. The semiconductor device of claim 1, wherein where there occur two or more write accesses, including a first write access and a second write access, to the same address group, at least one of the blocks is capable of merging the second and subsequent write accesses with the first write access into a single write access to the memory.

10. The semiconductor device of claim 1, wherein at least one of the blocks is a block that only translates the pseudo-physical address to the real physical address.

11. The semiconductor device of claim 1, wherein at least one of the blocks is capable of draining data from inside the block out to the memory.
